(19) United States
(12) Patent Application Publication
(10) Pub. No.: US 2006/0253358 A1
(43) Pub. Date: Nov. 9, 2006

(54) System and method for identifying and managing customers in a financial institution

(76) Inventors: David Delgrosso, Naperville, IL (US); Fraser Orr, Naperville, IL (US)

Correspondence Address: WALLENSTEIN & WAGNER, LTD., 311 SOUTH WACKER DRIVE, 53RD FLOOR, CHICAGO, IL, 60606, US

(21) Appl. No.: 11/400,037

(22) Filed: Apr. 7, 2006

Related U.S. Application Data
(60) Provisional application No. 60/669,535, filed on Apr. 8, 2005.

(51) Int. Cl. G06Q 40/00; G06Q 99/00; H04L 9/00; H04K 1/00

(52) U.S. Cl. 705/35; 705/67

(57) ABSTRACT

A system and method for managing a customer in a banking institution. The system includes a customer kiosk with biometric device for identifying the customer. The system places the customer in a virtual queue to see a service provider.

### CROSS-REFERENCE TO RELATED APPLICATIONS

The present invention claims the benefit of U.S. Provisional Application No. 60/669,535 filed Apr. 8, 2005.

### FEDERALLY SPONSORED RESEARCH OR DEVELOPMENT

Not Applicable.

### TECHNICAL FIELD

The invention generally relates to system and method for preventing fraud in a financial institution and managing customers use of the institution, and more particularly, to a system and method using biometrics to identify and authenticate customers and place them in one or more queues for obtaining services provided by the financial institution.

### BACKGROUND OF THE INVENTION

Many financial institutions and other similar institutions offer a variety of services to their customers. Not all of these services are handled by every employee at a single location. Instead, various tasks or services are handled by certain types of employees at various locations within the institution.

Studies have shown that having a structured queuing mechanism speeds up such queues because they provide structure and order. This eliminates confusion as to “who is up next,” and so forth. In fact, having a ticket based queuing mechanism (e.g., like those at a deli counter of a grocery store) is known to speed up the queue.

In an institution that provides numerous types of services, sometimes at various locations within the institution, it may be confusing which line to be in. Moreover, being in the wrong line can result in wasted time. This is especially true if there are steps the customer must perform prior to meeting with a service provider of the institution (e.g., filling out withdrawal forms, obtaining relevant documents or identification, etc.)

For institutions that handle a large number of customers for a large number of different services, it is imperative the institution be as efficient as possible. Accordingly, such institutions must find methods or systems for managing the customers as effectively as possible.

The present invention is provided to solve the problems discussed above and other problems, and to provide advantages and aspects not provided by prior systems or methods of this type. A full discussion of the features and advantages of the present invention is deferred to the following detailed description, which proceeds with reference to the accompanying drawings.

### SUMMARY OF THE INVENTION

The present invention provides a system that includes biometric functionality throughout an institution, such as a banking enterprise. This includes biometric support for both the employees and the customers for various services and procedures. Such services and procedures include, for example, door access, computer access and self identification.

The present invention provides facilities to biometrically identify customers to an existing banking platform; to correctly identify people when they open a new account (preventing account fraud); to allow staff to log in to their computers; and to allow staff to biometrically identify themselves for access to doors and other controlled areas. It also provides a lobby management tool to allow banks and other financial institutions to manage virtual queues of customers; and to provide identification of individuals at the drive-through or automatic teller machines.

The lobby management functions of the present system provides an effective use of both customers' time and bank staffs' time. Certain of these functions are initially provided at a customer kiosk. The kiosk can be utilized to identify the customer, place the customer in a virtual queue for the appropriate service provider for a desired transaction or service, and identify what actions the customer may need to take (e.g., filling out forms, obtaining documents, etc.) while waiting for the service provider rather than performing such actions when at the service provider's workstation (which would slow down the line).

Oftentimes a customer is unprepared for the transaction s/he wishes to undertake. By informing the customer up-front what s/he needs, the customer can decline service at that time (e.g., to obtain documents forgotten at home) and not waste time in line before being so advised.

The queuing mechanism can also be used to improve customer to service provider relationships by giving the service provider advance notice of the customer's desired transaction. For example, by the time the customer reaches the front of a queue and gets to the service providers workstation (e.g., a teller's window), the service provider can already have pulled up or be provided with the customer's record (which the customer can verify with a biometric check) and accounts. Additionally, the system can alert the service provider to any special needs or status (e.g., VIP or High Risk) of the customer.

Additionally, the system can direct customers with simple transactions to unmanned systems within the institution. These unmanned systems can also include biometric access.

The system places customers in queues depending on the services required. Such role based queuing allows the institution to better balance the transaction types. For example, particular types of loans might be directed to a specialist in a particular loan type. Similarly, non-account holders might be directed to a particular service provider while account holders may be directed to other service providers.

The system can also be used to accommodate customers of special value to the institution (i.e., VIP customers), such as customers with large net worth or an officer of a major institution customer. If the institution wishes to give specialized treatment to such customers, a special queue can be designated and an appropriate service provider can be alerted to the individual's presence. Similarly, the system can be used for customers that are high risk (e.g., known criminals) or who require special needs. Again, special queues can be designated for such customers and appropriate alerts sent to the service providers or others to facilitate their handling.

The kiosk system identifies a customer with an alphanumeric identifier (e.g., the customer's phone number or social security number) and biometric data, such as a fingerprint scan. The kiosk allows the customer to obtain a ticket either with identification or without identification. The kiosk will ask the customer which of a common range of services that customer wants. Additional services can be selected from additional screens. When a particular service is selected, the kiosk will then inform the customer what information and forms are needed for the service (this can be displayed as well as printed on the ticket). The customer can then secure such information and fill out the forms while waiting for service, or elect to obtain the service at a later time if the required information is not readily available. The kiosk allows the customer to select more than one service or task. Based on the service(s) or task(s) selected, the customer will be placed in the appropriate queue (each queue is a virtual queue in that it is maintained by the system and the customer does not have to stand in a specific line while waiting for the service provider).

The system can provide the customer with an estimated wait time based upon the knowledge of the customers currently in each queue and the average time required for the corresponding selected services.

The virtual queuing system provides a set of queues at each institution with different queue types. The kiosk puts the customer in the appropriate queue type for the service selected. As the customers are serviced, they are removed from the queues by the service providers.

The institution can define the queue types. Additionally, the system can include a standard set of default queues, such as: standard teller queue; non-account holder queue; personal banker queue; important customer queue; criminal (high risk) customer queue; and a special needs customer queue.

The system will pull up the customer's record before that customer arrives at a service provider workstation. However, the customer will be re-identified with a biometrics device before a transaction takes place at the service provider's workstation.

The queues are displayed on a lobby display (or on a plurality of displays throughout the institution). The display is continuously updated as customers move through the system.

The system includes a new account function. This function is the mechanism by which customers are entered into the system. It also provided both enrollment and fraud detection prevention.

The new account can be used to enroll a new customer into the system's customer database. Such enrollment can be set to require a certain number of fingerprint scans. Part of this procedure will include a search of customers already enrolled to verify that the same person is not enrolling as two different identities.

The system will provide the service providers with all recent transactions undertaken by the customer. This will enable detection of multiple new accounts, check fraud rings and other types of fraud.

The system will allow managers or administrators to track which employees can perform various functions. Additionally, all changes to a customer record are tagged by the person who performed that change.

The system also controls the drive-through functionality. This functionality is similar to the internal functionality except it does not include the kiosk. The biometrics device used for the drive-through customers must be tough, and weather and vandal resistant. The device must be mounted so that it is accessible through a car window.

The system also includes functionality for managing staff members (e.g., service providers). This includes identifying the member and designating the member's duties. A biometrics device is utilized for such identification.

In accordance with one embodiment of the invention, a system for identifying and managing customers in a financial institution comprises a customer login station (e.g., a kiosk) coupled to a database containing customer information. The customer login station is configured to receive customer identification data and customer desired service data from a customer. A server is coupled to the customer login station and is configured to receive the customer identification data and customer desired service data and assign the customer a position in a queue for a financial institution service provider suited to handle the desired service. A display is coupled to the server which visually indicates a customer's position in the queue. The financial institution can offer various services that are handled by different types of service providers. In this case, the system maintains and displays a variety of queues (e.g., one for each type of service provider).

The system further comprises a biometric device coupled to the customer login station, such as fingerprint scanner. The biometric device is set-up to obtain biometric data of the customer as part of the customer identification data.

The system further comprises a ticket dispenser at the customer login station. The ticket dispenser is configured to provide the customer with a ticket having a queue indicia (e.g., a number or letter which is displayed on the display). The ticket can be a sheet of paper. Additionally, the ticket can include additional information concerning the desired services, such as identification of information or documents needed, and forms that are required to be filled out by the customer. This allows the customer to prepare such information or forms while waiting in the queue.

A plurality of service provider workstations can be coupled to the server. The server provides customer information to each service provider workstation of the next customer in the queue for that service provider workstation. This can include identification information regarding the customer, account information, special needs information, the service(s) selected by the customer, alerts regarding the customer, special instructions for handling the customer, VIP status, high risk, etc. Each service provider workstation includes a biometric device coupled to the workstation. The biometric device at the service provider workstation is for re-verifying customer identification. It is also used for identifying the service provider to allow the service provider to login.

The system is configured to identify fraud. In this regard, the server is configured to provide an alert based on the receipt of customer identification data and customer desired service data that meets an alert criteria. The alert criteria can comprise, for example, inclusion of the customer on a watch list; an attempt by the customer to open more than one account within a predetermined time period; or more than one withdrawal by the customer within a predetermined time period.

In accordance with another embodiment of the invention, a customer check-in and management system for a multiple service type institution having multiple physical locations comprises a first customer kiosk having a biometric device at a first service institution location for sequentially servicing a plurality of customers. The customer kiosk is configured to obtain customer alphanumeric data and/or customer biometric data, as well as a service type selection from each customer. A customer database is coupled to the first customer kiosk containing customer information; and a computing device is coupled to the first customer kiosk and the customer database. The computing device is configured to assign each customer a position in a queue for the selected service type. A first display is coupled to the computing device. The first display visually depicts each customer's position in the queue for the selected service type at the first service institution location.

The system further comprises a second customer kiosk having a biometric device at a second service institution location for sequentially servicing a plurality of customers. The second customer kiosk is similarly configured to obtain customer alphanumeric data and/or customer biometric data, as well as a service type selection from each customer. A second display is coupled to the computing device. The second display visually depicts each customer's position in the queue for the selected service type at the second service institution location. The second customer kiosk and the second display are coupled to the customer database and the computing device via a network connection, such as the Internet or a wide area network (WAN).

In accordance with yet another embodiment of the invention, a method of authenticating and managing customers in a multiple service institution comprises the steps of: providing a computerized customer station having a biometric device for initial customer identification and service type selection; requesting alphanumeric customer identification data at the station from a customer; obtaining biometric data of the customer at the station with the biometric device; requesting selection of a service type at the station from the customer; providing the customer a queue position for a service provider at the institution of the service type; and, displaying the queue position of the customer on a display.

The method further comprises providing an alert if at least a portion of information obtained from the customer meets a predefined criteria. Such information includes the alphanumeric data, the biometric data and the service type. Additionally, the information can include prior customer transactions, especially those occurring within a predetermined time frame before the current transaction.

The method can further comprise providing customer account information electronically to the service provider when the customer is at the front of the queue. This facilitates efficiently moving the customer through the system.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1 is a graphical illustration of a customer identification and management system in accordance with the present invention;

FIG. 2 is a screenshot requesting customer information displayed in a customer kiosk used in the system of FIG. 1;

FIG. 3 is a screenshot directing a customer to a biometrics device displayed in the customer kiosk used in the system of FIG. 1;

FIG. 4 is a screenshot for identifying one or more desired services displayed in the customer kiosk used in the system of FIG. 1;

FIG. 5 is a queue display used in the system of FIG. 1;

FIG. 6 is a screenshot requesting an employee to login with a biometrics device displayed on a workstation of the system of FIG. 1;

FIG. 7 is a screenshot requesting an employee to choose a service role displayed on a workstation of the system of FIG. 1;

FIG. 8 is a screenshot of a customer's information displayed on a workstation of the system of FIG. 1;

FIG. 9 is a block diagram illustrating an existing customer's use of the present system to obtain services from the financial institution;

FIG. 10 is a block diagram illustrating a customer's use of the present system that skips authentication at the customer kiosk;

FIG. 11 is a block diagram illustrating a customer's use of the present system to enroll into the system;

FIG. 12 is a block diagram illustrating an existing customer's use of the system to open another account;

FIG. 13 is a ticket printed out at the kiosk of the system of FIG. 1 and,

FIG. 14 is a fingerprint scanner for use in the system of FIG. 1.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

The present invention provides a system and method for identifying and managing customers, as well as employees, at an institution—such as a financial institution. A financial institution typically provides its customers with a variety of services, such as banking services, mortgage services, loan services, currency exchange services, etc., which may be handled by different types of financial institution employees at different locations within the financial institution. The present system streamlines identification of the customers and directs the customers' movement to the proper location in the financial institution. Additionally, the system can be used to coordinate and track customer transactions at more than one branch of the institution.

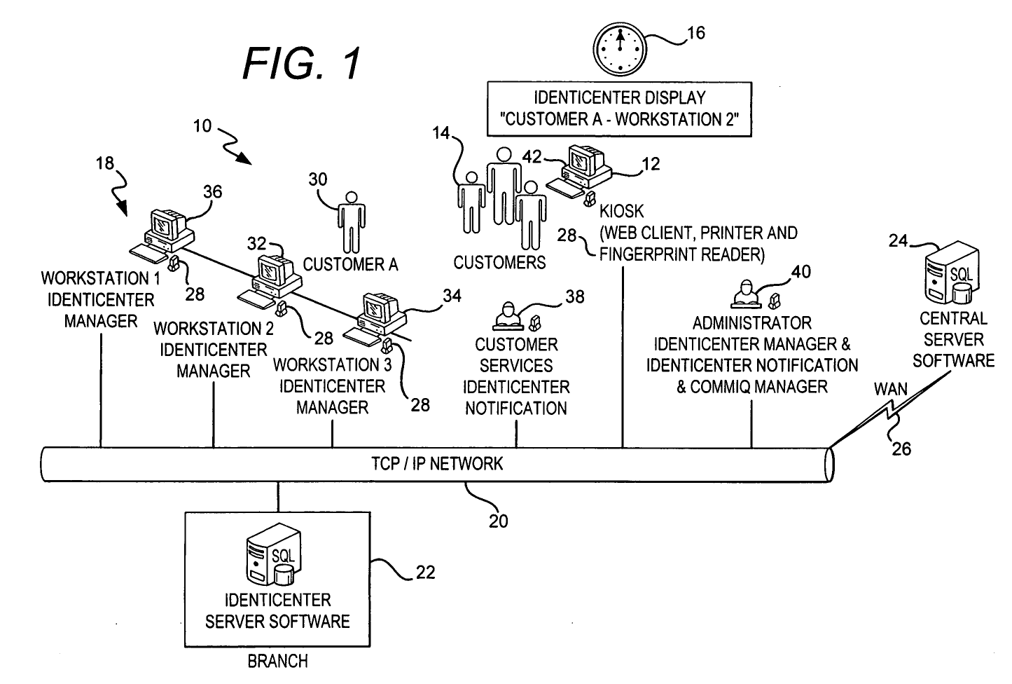

Referring to FIG. 1, components of an identification and management system 10 of the present invention are graphically illustrated. The system 10 includes a customer kiosk 12 which can be utilized by a plurality of customers 14, a central queue display 16, and a plurality of workstations 18. These components are coupled or connected via a network connection, such as a local area TCP/IP network 20, to a branch server 22 running software for implementing all or most of the present system 10 (the connection to the display is not shown in FIG. 1). The branch server 22 provides primary control of the system 10. Additionally, other servers and/or databases, such as a central server 24, can be connected to these components via the TCP/IP network 20, or via a wide area network (WAN) connection 26 (or other network connections, such as a wireless network or the Internet). The central server 24 can be, for example, the “administrative server system” as described in U.S. patent application Ser. No. 11/051,259 (“the '259 application”) filed Feb. 4, 2005, the contents of which are incorporated herein by reference. The '259 Application is titled “Access Administration System And Method For A Currency Compartment.” Similar to the administrative server system of the '259 application, the central server 24 can provide at least all of the same functionality as the administrative server system for receiving and storing customer and/or bank employee complete biographic, financial, credit, residential, biometric, legal, and other necessary information for utilization within the context of the present invention. For example, once a bank employee information is received and stored (“set up”) within the central server 24, the system can then use this information to determine whether to assign a bank customer to this particular bank employee for serving of such bank customer, based on the information stored within the central server 24, including the bank employee's assigned tasks and/or capabilities. Many other uses of the bank employee and/or bank customer's information will be understood with reference to other portions of the above and below description.

The customer kiosk 12 is used to initially identify customers to the financial institution and manage their movements throughout the institution. While only one kiosk 12 is shown in FIG. 1, it will be understood that two or more kiosks can be utilized (especially for financial institutions that typically service a large number of customers on a daily basis). The kiosk 12 is preferably placed in the lobby of the financial institution.

The customer kiosk 12 can be in the form of a personal computer or other similar interactive device (e.g., an automatic teller machine) which is coupled to a biometrics device 28. The kiosk 12 includes a keyboard or other input means, such as a touch screen and/or a plurality of dedicated function controls or buttons for enabling a customer to enter information into the system 10. Additionally, the kiosk 12 can also include a card reader.

In normal operation, the customer signs into the system 10 using the kiosk 12 upon arriving at the financial institution. In this regard, the kiosk 12 is configured or set-up to obtain identification information from the customer. This information can include alphanumeric customer identification data, such as an account number, telephone number, social security number, personal identification number (pin) or other password, etc. The kiosk 12 also obtains biometric data of the customer from the biometrics device 28. This customer information is compared to information stored in a customer database coupled to the kiosk 12 via one or both of the network connections 20 and 26. Preferably, the customer information is stored in a database associated with the central server 24.

The kiosk 12 also allows the customer 14 to select one or more desired service or transaction types the customer is interested in performing at the institution. These can include deposits, withdrawals, payments on loans, payments of bills, obtaining foreign currency, or any other service offered by the institution.

Upon identification of the customer 14 and selection of one or more service types, the customer is given an identifier (e.g., some indicia—such as a number or letter) and is entered into a queue for an appropriate service provider at the institution. In the example illustrated in FIG. 1, one particular customer 30 is assigned the designation “Customer A” and is entered into the queue for “workstation 2” 32. The customer's designation is also displayed on the display 16. The kiosk 12 can provide the customer with a ticket or piece of paper with the identifier printed thereon. It is fully appreciated that near the kiosk or workstation 18, a lounge or wait area is available for customers. In this wait area, customers can relax or fill out necessary paperwork and look at the display 16, without having to stand and wait in a line.

A separate queue can be set up for each workstation 18, department or other location a customer may need to visit at the institution to complete the selected service type(s). In some instances, a single queue can be set up covering a plurality of workstations 18. For example, one queue can be used for teller services which may be handled by a group of tellers (e.g., workstations 32, 34, 36), and would direct the customer to the next available teller in the group. Alternatively, other departments, such as customer services 38 or the bank administrator 40 may only have one workstation.

The central display 16 can be configured to show each customer's position in their respective queue. The display 16 can also provide an estimated wait time or other pertinent information. The central display 16 can also be a plurality of monitors positioned throughout the institution.

The local server 22 includes the programming to coordinate the system 10. This includes managing the various queues and updating the display 16 as customer 14 are serviced and move through the institution completing their transaction(s).

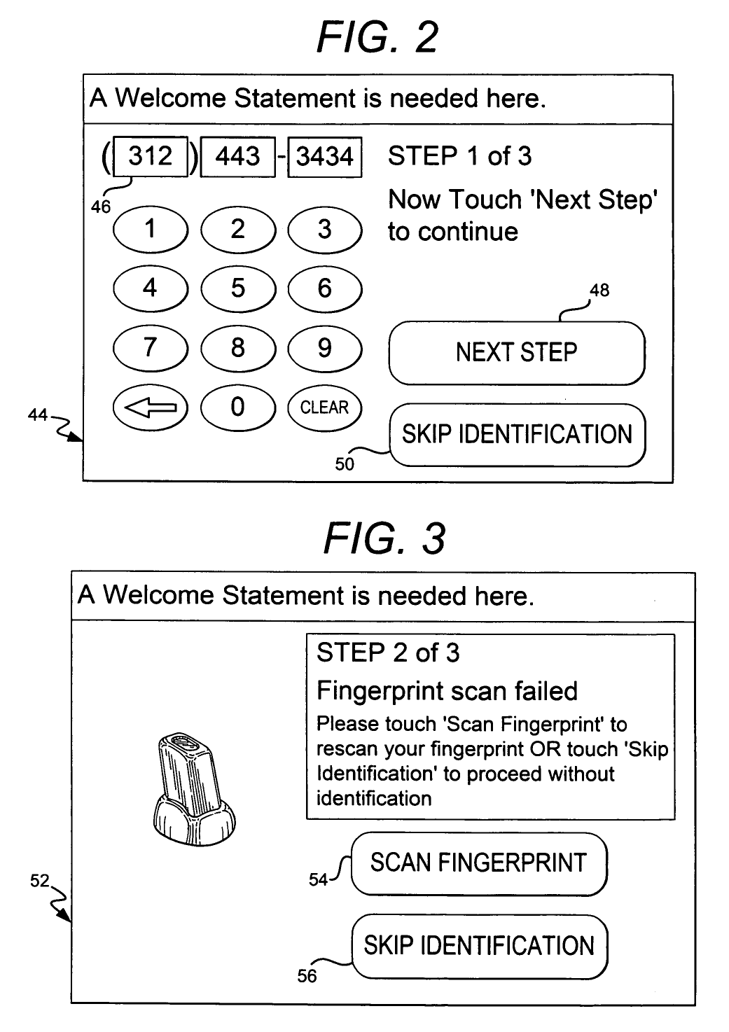

The kiosk 12 includes its own display 42. As illustrated in FIG. 2, a customer using the kiosk 12 is presented with a welcome or initial screenshot 44. This initial screenshot 44 requests alphanumeric identification data 46, such as the customer's phone number. The screen 44 additionally provides an icon or link 48 to the next step in the identification process. It also provides a link 50 for skipping identification (this may be utilized, for example, by new customers who are not yet enrolled in the system 10).

A second screenshot 52, illustrated in FIG. 3, directs the customer to use the biometrics device 28 associated with the kiosk 12. In the present example, the biometrics device 28 is a fingerprint scanner as illustrated in FIG. 14. The biometrics device can be connected directly to and/or be in close proximity to the kiosk 12 (and, if not connected directly to the kiosk, connected to the network connection 20). The second screenshot 52 includes a link 54 to initiate the fingerprint scan, and another link 56 to skip the identification.

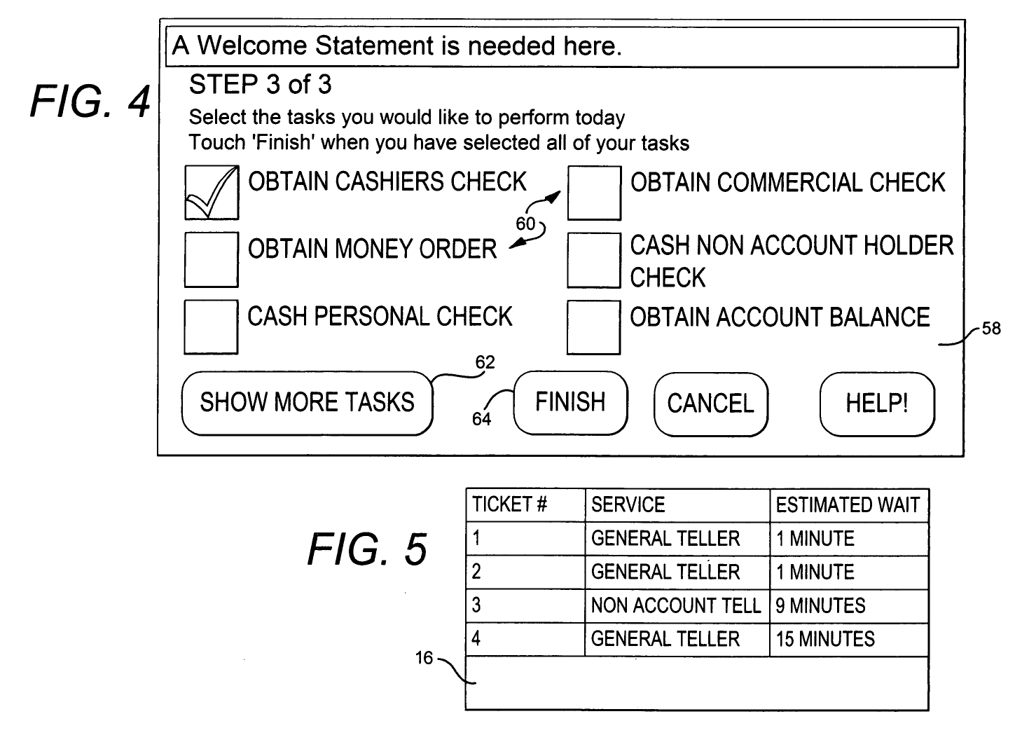

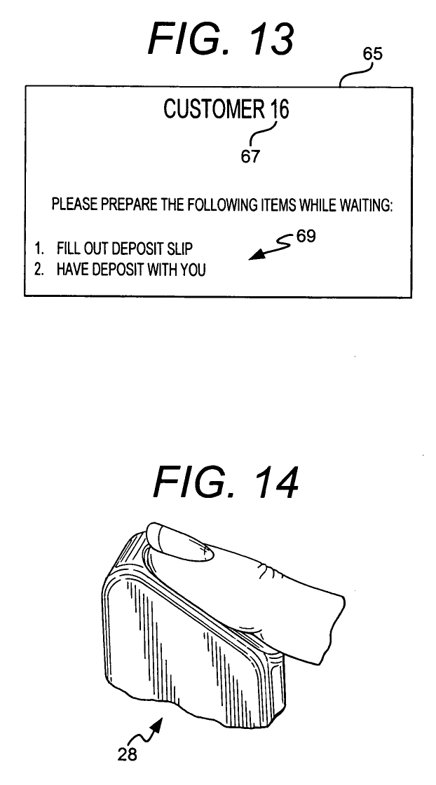

After a successful scan of the customer's finger print, the kiosk 12 proceeds to a third screenshot 58 for selecting a service type 60 (i.e., task or transaction desired) as illustrated in FIG. 4. The screenshot 58 identifies some of the more common tasks performed by the institution, and includes a link 62 to obtain a showing of more tasks. After selection of one or more desired service type(s) 60, the customer can touch the “Finish” icon 64. The kiosk 12 (under the direction of the server 22) then prints out a ticket 65 for the customer on a printer associated with the kiosk 12. An example ticket 65 is illustrated in FIG. 13. The ticket 65 identifies the customer's number (or other identifying indicia) 67 for the service provider needed for the service(s) selected. If more than one service provider is required to accomplish all of the selected tasks, the customer can be placed in the next queue after obtaining service from a first service provider. The customer number 67 is an arbitrary number identifying the customer. It permits the display 16 to display the customer number as opposed to customer identifying information, such as a name. The ticket 65 can also display instructions or other information 69 relevant to the requested services or transaction. The instructions 69, some of which can be performed while waiting in the queue (e.g., “Fill Out Deposit Slip”), facilitate completion of the service and expedite the process.

Information resulting from the customer's use of the kiosk 12 is transmitted to the server 22. The server 22 then causes the customer's ticket number, customer number, or other indicia to be shown on the display 16 along with an estimated wait time as illustrated in FIG. 5. The display 16 can also indicate the type of service provider the customer is in the queue to see (as is evident from the Figures, the customer's position in the queue does not require the customer to stand in a line). The display 16 is periodically updated as customers are serviced and waiting customers move up in their respective queues. It should be recognized that the queue is “virtual.” It is not a physical line requiring a customer stand in. Rather, it is place set by the server 22 and posted on the display 16.

In addition to identifying the customer and placing the customer in the appropriate queue, the kiosk 12 can also identify and/or print out a list of items and/or actions needed to facilitate the service type selected. For example, a customer seeking to withdraw money from an account may need to fill out a withdrawal slip. The list can direct the customer to a location where the customer can obtain and fill out the withdrawal slip while waiting in the queue.

Referring back to FIG. 1, when the customer 30 that has received a ticket is at the front of the queue, he or she is directed to the appropriate service provider (in this example, the service provider at “workstation 2” 32). Each of the workstations 18 includes a personal computer connected to the network connection 20.

The customer 30 is again requested to provide the alphanumeric identification data and/or biometrics data. To obtain the biometrics data, each workstation 18 is provided with a biometric device 28 similar to the one associated with the kiosk 12, such as a fingerprint scanner. This process confirms that the correct customer is at the correct location. This also prevents fraud as the customer must provide the biometric information in front of a service provider.

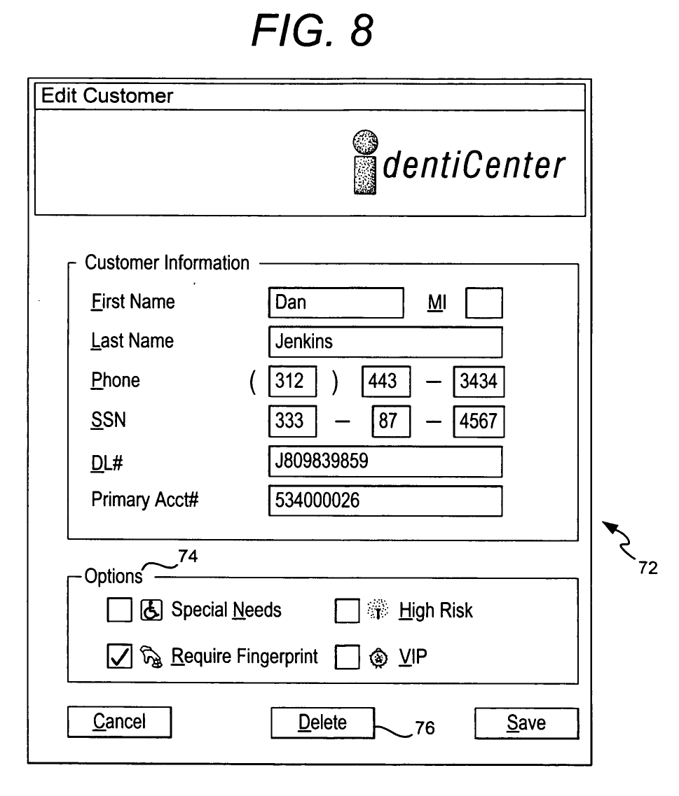

Certain customers may request that access to their accounts only be granted after a mandatory fingerprint check. This will be indicated on the service provider's workstation display. The service provider can set up the system to implement the customer's request by checking the appropriate box under Options 74 (see FIG. 8).

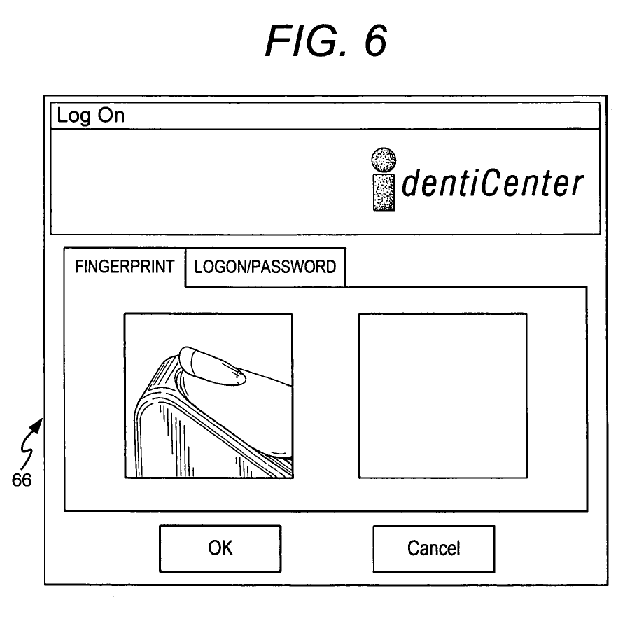

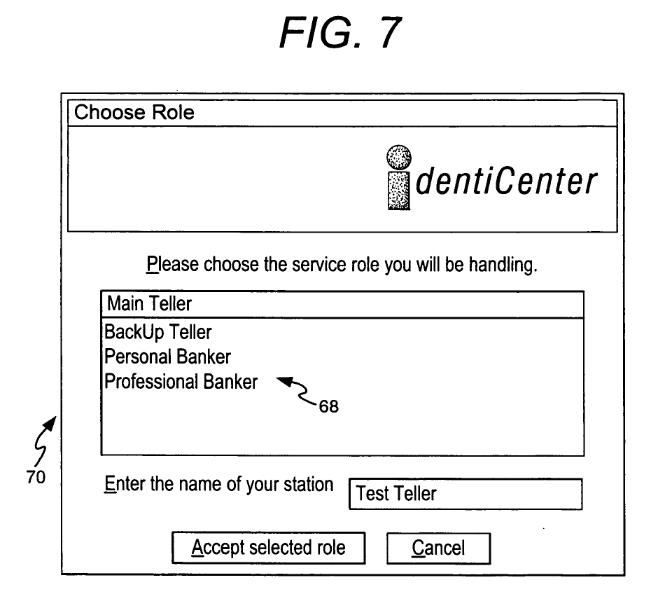

The biometrics devices 28 at the workstations 18 are also utilized by the system 10 to identify and login the service provider presently at the workstation. Similar to the customer kiosk 12, the service provider is presented with one or more screenshots, such as the screenshot 66 shown in FIG. 6, directing the service provider to login and to utilize the biometrics device 28. After utilizing the biometrics device 28, the service provider is directed to indicate a service role 68, as illustrated in the screenshot 70 of FIG. 7. Such service roles 68 can include, for example, “Main Teller,” “Backup Teller,” “Personal Banker,” and “Professional Banker.”

In addition to identifying the customers and managing the queues, the branch server 22 also coordinates obtaining account and other information of the customer for display on the service provider's workstation when the customer is at the front of the queue. This can include account(s) balance(s), recent transactions, special needs information, etc. This is done for each customer as they proceed to the front of their respective queues.

All customer activity can be sent to, and retrieved from, the central server 24 or any centrally available database. Accordingly, each local branch server 22 can communicate with the central server 24 (or other database) to make sure it has all transaction data of the customer from any branch location for display on the appropriate workstation. Any new transactions conducted at the branch at issue will be forwarded to the central server 24 so that other branches can obtain updated transaction information if needed.

Once the customer is verified, the service provider is able to edit the customer information, delete the customer, re-enroll the customer's fingerprints, and create and edit customer notes. FIG. 8 illustrates a screenshot 72 for allowing the service provider to edit the customer's information. In addition to editing various customer data, such as name, phone number, social security number, etc., the service provider can also select or unselect various Options 74. These include “Special Needs,” “High Risk,” “Require Fingerprint,” and “VIP.” The Options 74 will facilitate the service provider's handling of the customer. The screenshot 72 can also be used to delete the customer via a delete icon 76.

If a customer is identified as a VIP, the customer's identity can be broadcast to all displays of individuals providing services. In this manner, all service providers know of the presence of a VIP in the institution.

The system 10 can be utilized to manage the tasks, services and roles of each of the service providers. A task is a job or step to perform in furtherance of a service. A service is typically formed from one or more tasks (e.g., a group of tasks). Services can include, for example, obtaining cashiers checks or money orders, cashing checks, and applying for loans (e.g., business, personal, car, mortgage, etc.). A role defines the types of services and tasks a particular service provider may perform. Roles can include, for example, a general teller, personal banker commercial banker, and a non-account teller. An administrator 40 is provided the rights to configure the roles, services and tasks for the institution. Managers may be given restricted access to the configuration options.

The present system 10 can also be used to identify and manage drive-through customers (for those branches having drive-through tellers). The drive-through can include a biometrics device 28, and an alphanumeric input. Upon identification, the system 10 provides the drive-through teller with customer information and desired services to facilitate and expedite servicing such customers.

One of the benefits of the system 10 described is that it can be used to identify potential or actual fraudulent activity, and to alert the service provider and/or others at the institution of such activity. According to one example, the system 10 can provide alerts for customers designated “High Risk.”

According to another example, the system 10, by utilizing the biometrics device 28, can determine whether the customer has opened or tried to open more than one account at different (or the same) branches using different (or the same) names. Similarly, the system 10 can determine if the same customer has attempted to make multiple withdrawals under a different (or same) name within a predetermined period of time. Other alert conditions can also be set up in the system 10 as necessary.

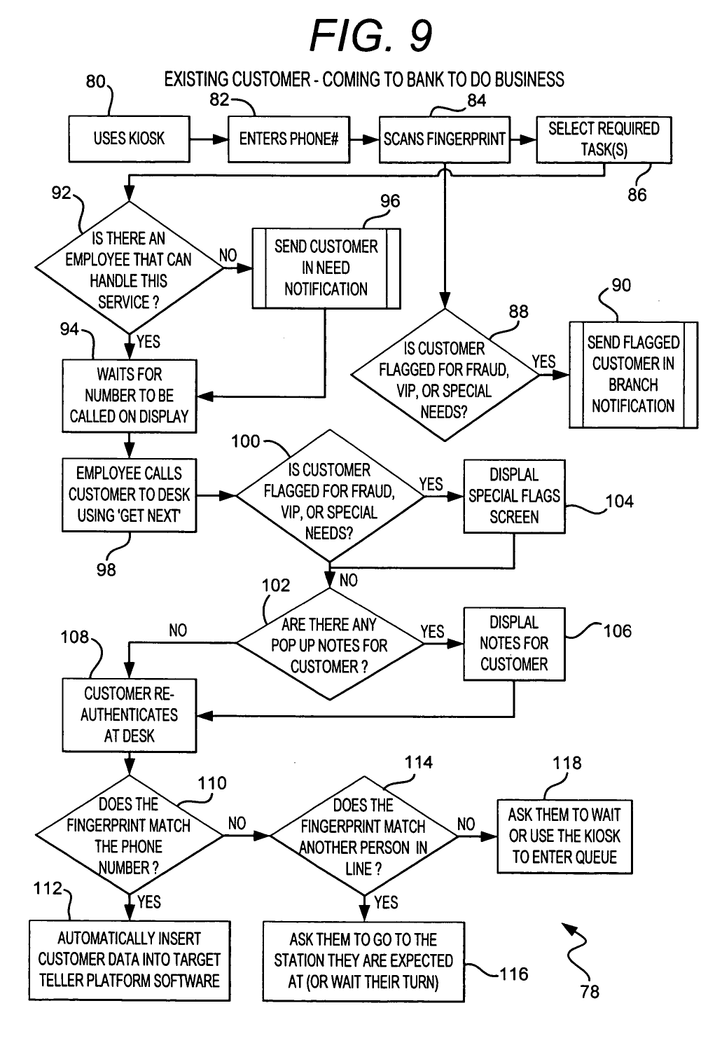

The block diagram 78 of FIG. 9 illustrates an existing customer's use of the system 10. Starting at the first block 80, a customer enters alphanumeric data (in this case the customer's phone number) 82 and then proceeds with use of the biometrics device (e.g., fingerprint scanner) 84 and selection of desired tasks or services 86. Upon use of the biometrics device, the system 10 can flag the customer 88 if the customer meets the criteria for one of the fraud alerts, or as a special needs or VIP customer, and send the appropriate alert or notification 90 to the service providers and/or administration personnel.

The system 10 then checks for the appropriate service provider 92 and places the customer in the wait queue for the service provider 94. If no service provider is available the customer is provided with a notification 96.

When the customer proceeds to the front of the queue, the service provider calls for the next customer 98. The system 10 again checks for any flags 100 as well as any notes relating to the customer 102. Any flags 104 or notes 106 are displayed on the service providers workstation 18.

The customer is then asked to re-authenticate his identity 108 with a biometrics device 28 and/or alphanumeric data. If the biometrics data and/or alphanumeric data matches 110, the customer's information is automatically provided 112 to the service provider's workstation 18. If the biometrics data matches another customer in the queue (or another queue) 114, the customer is directed to wait or to proceed to the appropriate service provider. 116. Otherwise, the customer is directed to the kiosk 118.

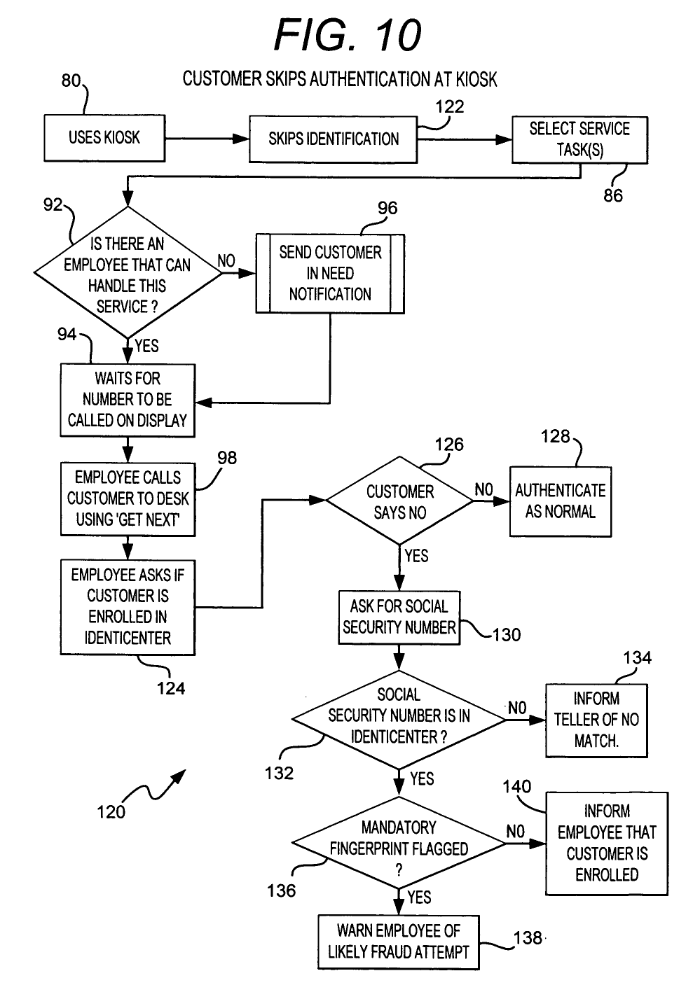

The block diagram 120 in FIG. 10 illustrates handling of a customer that skips identification 122 when using the kiosk 80. When the customer reaches the service provider, the customer is asked whether he or she is enrolled in the system 124. The customer's response 126 determines the next action. If the customer is enrolled, the service provider will authenticate the customer as normal 128. If not, the service provider will ask for the customer's social security number 130 and determine if that number is in the system 132. If the social security number is not in the system the service provider is notified and can take steps to enroll (or direct the customer to the appropriate location) the customer.

The system 10 also checks customer's biometrics data 136. If flagged, the service provider is provided with an appropriate notification (e.g., a fraud alert) 138. Otherwise the service provider is notified the customer is enrolled 140.

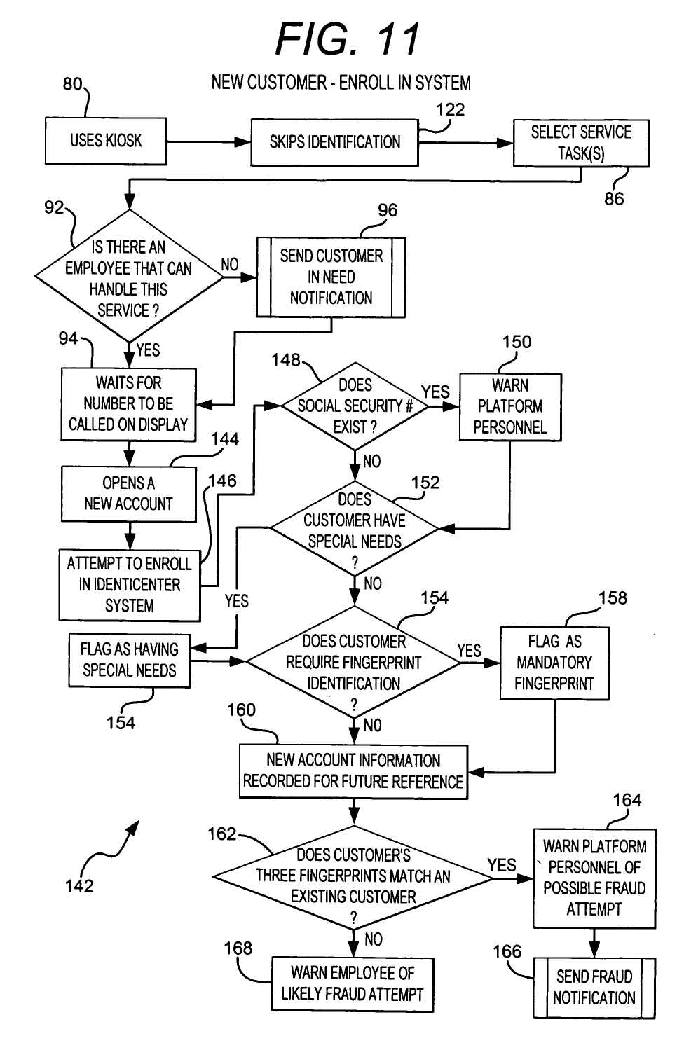

FIG. 11 provides a block diagram 142 illustrating the steps of enrolling a new customer 146 attempting to open a new account 144. In addition to obtaining certain information from the customer, the enrollment includes determining if the customer's social security number exist 148 in the system. If yes, the service provider is warned 150. If not, the service provider determines if the customer has special needs 152 and flags this fact if appropriate 154 on the customer information screen (see FIG. 8). Similarly, the service provider determines if the customer wants mandatory fingerprint identification 156 and flags this fact if so 158. The new account information is recorded for future reference 160.

The system also determines if the new customer's fingerprint matches another customer's fingerprint 162. If so, the system warns of possible fraud 164 and sends an alert 166. Otherwise, the customer is enrolled 168.

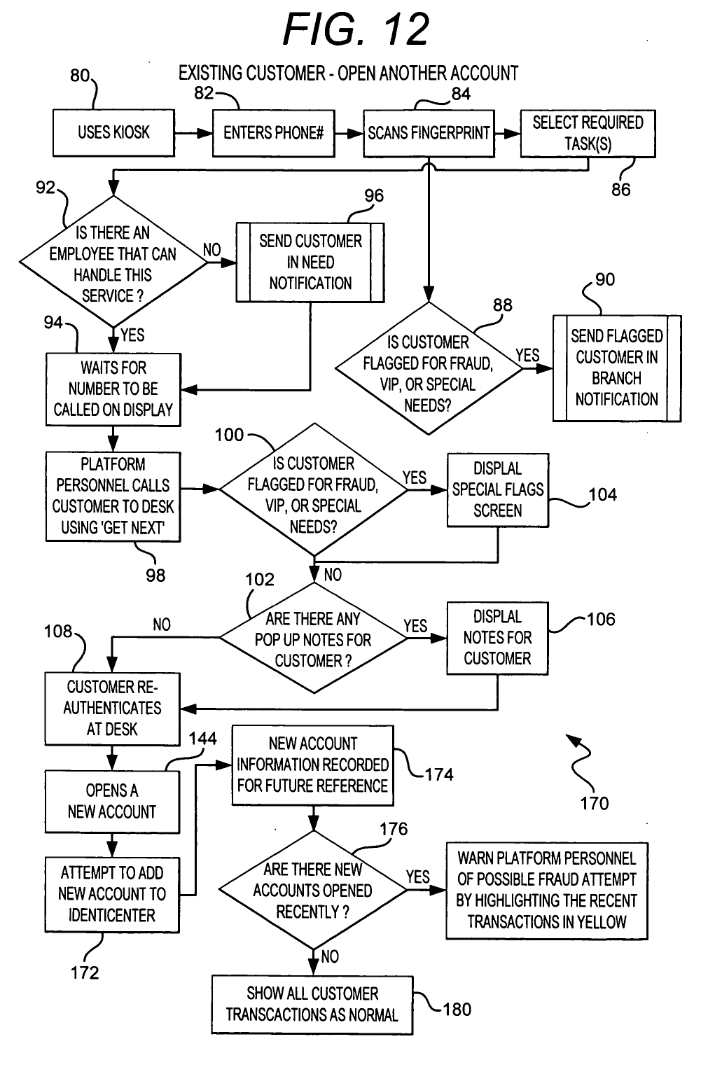

FIG. 12 provides a block diagram 170 illustrating an existing customer attempting to open a new account 144. In this case, the service provider attempts to add a new account to the system 172 and obtains and records information for the new account 174. The system 10 looks at whether any other new accounts had been opened by the customer within a recent predetermined time period 176. If so, the system will provide an alert of a possible fraud 178. Otherwise, the transaction will appear as normal 180.

The system 10 can be configured to allow the institution (i.e., a user of the system 10) to require—that is, make mandatory—use of the biometrics device 28 for the customers or the employees at any or all stages of the process.

The system 10 generally illustrated in FIG. 1 and described herein can be implemented at more than one branch of the institution. In this instance, each branch can connect to the same central server 24 and any associated customer databases. Thus, transactions conducted at one branch by a customer will be immediately available for service providers at another branch.

While the specific embodiments have been illustrated and described, numerous modifications come to mind without significantly departing from the spirit of the invention, and the scope of protection is only limited by the scope of the accompanying Claims.

What is claimed is:

1. A system for identifying and managing customers comprising:
a customer login station coupled to a database containing customer information, the customer login station configured to receive customer identification data and customer desired service data from a customer;
a server coupled to the customer login station configured to receive the customer identification data and customer desired service data and assign the customer a position in a queue for a service provider suited to handle the desired service; and,
a display coupled to the server, wherein the display visually indicates a customer's position in the queue.

2. The system of claim 1 further comprising a biometric device coupled to the customer login station wherein the biometric device is setup to obtain biometric data of the customer as part of the customer identification data.

3. The system of claim 2 wherein the biometric device is a fingerprint scanner.

4. The system of claim 1 further comprising a dispenser at the customer login station, configured to provide the customer with a written customer number having a queue indicia.

5. The system of claim 1 further comprising a plurality of service provider workstations coupled to the server wherein the server provides customer information to each service provider workstation of the next customer in the queue for that service provider workstation.

6. The system of claim 5 wherein in each service provider workstation includes a biometric device coupled to the workstation.

7. The system of claim 2 wherein the server is configured to provide an alert based on the receipt of customer identification data and customer desired service data that meets an alert criteria.

8. The system of claim 7 wherein the alert criteria comprises inclusion of the customer on a watch list.

9. The system of claim 7 wherein the alert criteria comprises an attempt by the customer to open more than one account within a predetermined time period.

10. The system of claim 7 wherein the alert criteria comprises more than one withdrawal by the customer within a predetermined time period.

11. A customer check-in and management system for a multiple service type institution having multiple physical locations comprising:
a first customer kiosk having a biometric device at a first service institution location for sequentially servicing a plurality of customers, the customer kiosk configured to obtain customer alphanumeric data and customer biometric data, the customer kiosk further configured to obtain a service type selection from each customer;
a customer database coupled to the first customer kiosk containing customer information;
a computing device coupled to the first customer kiosk and the customer database, the computing device configured to assign each customer a position in a queue for the selected service type; and,
a first display coupled to the computing device wherein the first display visually depicts each customer's position in the queue for the selected service type at the first service institution location.

12. The system of claim 11 wherein the biometric device at the customer kiosk is a fingerprint scanner.

13. The system of claim 11 further comprising
a second customer kiosk having a biometric device at a second service institution location for sequentially servicing a plurality of customers, the second customer kiosk configured to obtain customer alphanumeric data and customer biometric data, the second customer kiosk further configured to obtain a service type selection from each customer; and,
a second display coupled to the computing device wherein the second display visually depicts each customer's position in the queue for the selected service type at the second service institution location wherein the second customer kiosk and the second display are coupled to the customer database and the computing device via a network connection.

14. The system of claim 11 further comprising a plurality of service provider computers coupled to the computing device wherein each service provider computer is coupled to a biometric device.

15. The system of claim 11 wherein the computing device is configured to provide a potential fraud alert based on the customer alphanumeric data, biometric data and service type selection obtained from one of the plurality of customers serviced by the first customer kiosk.

16. A method of authenticating and managing customers in a multiple service institution comprising the steps of:
providing a computerized customer station having a biometric device for initial customer identification and service type selection;
requesting alphanumeric customer identification data at the station from a customer;
obtaining biometric data of the customer at the station with the biometric device;
requesting selection of a service type at the station from the customer;
providing the customer a queue position for a service provider at the institution of the service type; and,
displaying the queue position of the customer on a display.

17. The method of claim 16 wherein the step of obtaining biometric data of the customer with the biometric device comprises the step of:
scanning a fingerprint of the customer.

18. The method of claim 16 further comprising the step of:
providing the customer with a list of one or more documents required for the service type.

19. The method of claim 16 further comprising the step of:
providing an alert if at least a portion of information obtained from the customer meets a predefined criteria wherein the information includes the alphanumeric data, the biometric data and the service type.

20. The method of claim 16 further comprising the step of:
providing customer account information electronically to the service provider when the customer is at the front of the queue.
